(19) United States
(12) Patent Application Publication
(10) Pub. No.: US 2018/0328606 A1
(43) Pub. Date: Nov. 15, 2018

(54) CLIMATE CONTROL MATERIALS, APPARATUS, AND SYSTEMS

(71) Applicant: Anaele Diala Iroh, Blantyre (MW)

(72) Inventor: Anaele Diala Iroh, Blantyre (MW)

(21) Appl. No.: 15/979,356

(22) Filed: May 14, 2018

Related U.S. Application Data
(60) Provisional application No. 62/505,204, filed on May 12, 2017.

(51) Int. Cl. F24F 5/00; C04B 33/04; C04B 33/13; C04B 33/32

(52) U.S. Cl. CPC F24F 5/0035; C04B 33/32; C04B 33/131; C04B 33/04

(57) ABSTRACT

Systems and methods are provided for materials, methods for making such materials, and apparatus and systems using such materials, which may be used for climate control, that is, cooling or warming using water evaporation and condensation to efficiently cool or warm living spaces, devices, and equipment with or without electricity and in any climate. The materials may comprise clay, carbon, and a metal, and may be formed, treated with water or other substances, and baked. The materials may be incorporated into apparatus and systems that provide cooling and/or heating.

### FIELD OF THE INVENTION

The presently disclosed subject matter relates to providing materials, methods for making such materials, and apparatus and systems using such materials for efficient interior and exterior climate control and heat removal, and in particular, the present disclosure is directed to materials, methods for making such materials, and apparatus and systems using such materials which may be used for cooling or warming using water evaporation and condensation to efficiently cool or warm living spaces, devices, and equipment with or without electricity and in any climate.

### BACKGROUND OF THE INVENTION

The present disclosure is directed to materials, methods for making such materials, and apparatus and systems using such materials that may be used to cool or heat a space. The present invention may be used with or without electricity, and may be used in any climate.

When water evaporates, transitioning from liquid to gas form, it absorbs energy in the form of thermal energy, or heat, from the surrounding space and objects, producing a reduction in temperature in the immediate surroundings. This process, known as evaporative cooling, is a process which cools Earth when water vapour evaporates from the surface or from plants into the atmosphere, and which cools a human body through the mechanism of perspiration. When water vapour condenses, transitioning from gas to liquid, energy is released in the form of thermal energy, or heat, into the surrounding space. This condensation of vapour process is how conventional air conditioners remove water from the air: by condensing the vapour, and absorbing the heat of condensation generated by removing humidity, with a cold coil containing a refrigerant substance. The cooling effect of evaporation has been harnessed in simple forms for a long time. For example, earthenware pots have long been used to cool water, and pot-in-pot systems having a smaller pot within a larger pot containing water and sand may be used to cool food within in the inner pot. In modern times, evaporative cooling has been employed in “swamp coolers” which blow air through water soaked pads to achieve cool air for air conditioning in hot dry climates. Adsorption of gas has been used in climate control systems that depend on the phase change of materials in desiccant cooling and heating systems.

While the use of evaporation for cooling has long been recognized, it has not been as effective as cooling systems employing refrigerants in humid climates; therefore, its use in non-arid conditions is not common or effective. This presents a problem in that many potential applications of evaporative cooling are foreclosed, because the existing art of evaporative cooling climate control systems has not presented an effective and affordable system or apparatus for use in any environment, in particular in humid environments.

Refrigerant-based systems now provide the primary methods of cooling for indoor spaces and food preservation. However, problems with such systems include the fact that they have very high energy requirements, making them expensive to operate. A further problem with refrigerant systems is the negative externalities they impose on the environment in the forms of pollution from manufacturing, use, and disposal—as well as, in the case of fluorocarbons and related refrigerant chemicals, damage to the ozone layer. In addition, in locations where the supply of electrical energy is limited or unreliable, it may be impossible to keep such systems operational. Therefore, while modern refrigerant-based cooling systems can provide excellent cooling when operational, the cost of such systems in electricity consumption and environmental damage is problematic, and in some settings, they are not reliable.

### SUMMARY OF THE INVENTION

The present invention meets all these needs, by disclosing materials, methods for making such materials, and apparatus and systems using such materials that may be used to cool or heat a space. The goal of the present invention is to provide a solution for evaporative cooling, or the inverse, namely, condensation heating, that may be used in any environment, even in humid environments.

Various embodiments of the present invention include a ceramic material composed for climate control and heat removal, comprising a combination of clay, activated carbon and optionally aluminum, wherein the composition is fired to form a ceramic material. The ceramic composition may be used in a climate control unit, also referred to in the present disclosure as a climate control apparatus. The climate control unit may be in any of several forms, such as small rocks or tubes that sit on a bed of water, or in the form of a ceramic vessel configured to hold water, such that water may be soaked up through capillary forces to the surface of the rock or tubes, or pass through the walls of the vessel and evaporate, cooling the surrounding air and removing heat from objects in the vicinity of the climate control unit. In addition, water vapour present in the surrounding air condenses on the surfaces of the climate control unit, reducing the water content of air in humid climates. A climate control unit of the present invention may be used in an evaporative cooling climate control system wherein the climate control unit may be a component within a housing of the climate control system. Phase change energy in the system may be used for cooling a building space, or object for example. The materials, methods for making such materials, and apparatus and systems using such materials may be used in humid environments.

The present invention also provides advantages over existing refrigerant systems, by presenting lower costs for ownership, lower costs for operation, and fewer negative externalities in the form of harms to human health and the environment. In this way, the present invention presents improvements in consumer choice and options for evaporative cooling and heat removal systems.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, the drawings show exemplary embodiments; but the presently disclosed subject matter is not limited to the specific methods and instrumentalities disclosed. In the drawings, like reference characters generally refer to the same components or steps throughout the different figures. In the following detailed description, various embodiments of the present invention are described with reference to the following drawings, in which:

FIG. 1 is a side view of a climate control unit according to various embodiments of the present invention.

FIG. 2 is a vertical cross section of a climate control unit according to various embodiments of the present invention.

FIG. 3 is a vertical cross section of another climate control unit according to various embodiments of the present invention.

FIG. 4 is a side perspective view of a fluid collector according to various embodiments of the present invention.

FIG. 5 is a schematic illustration of an exemplary climate control system, shown from a side perspective.

FIG. 6 is a schematic illustration of the climate control system of FIG. 5 from a top perspective.

FIG. 7 is a top perspective view of the interior of an embodiment of a climate control system of the present invention.

FIG. 8 is a side view, with a portion of the side removed to reveal the interior, of the embodiment of a climate control system of FIG. 7.

FIG. 9 is a top view of the interior of the embodiment of a climate control system of FIG. 7.

FIG. 10 is a side view of the interior of the embodiment of a climate control system of FIG. 7.

FIG. 11 is a perspective view of an embodiment of a climate control unit of the present invention placed in a pot with a potted plant.

FIG. 12 is a side elevation view of an alternative embodiment of a climate control unit placed in a pot with a potted plant.

FIG. 13 is a side elevation view of another alternative embodiment of a climate control unit placed in a pot with into a potted plant.

FIG. 14 is a cross sectional view, along a vertical place, of another embodiment of a climate control unit placed in a pot with a potted plant.

FIG. 15 is a perspective view, from the top and front, of another embodiment of a climate control unit placed in a pot with a potted plant.

FIG. 16 shows four separate plots of datasets, labeled as plots A, B, C, and D, showing results of air cooling experiments using a climate control unit of the present invention.

FIG. 17 depicts a side elevation view of an embodiment of the present invention.

FIG. 18 depicts a top elevation view of the embodiment of the present invention of FIG. 17.

FIG. 19 depicts another top elevation view of the embodiment of the present invention of FIG. 17.

FIG. 20 depicts a front perspective view of the embodiment of the present invention of FIG. 17.

FIG. 21 presents a schematic view of the materials used to make certain embodiments of the present invention, and of the methods of making the embodiments of the present invention.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the apparatus and methods of the present invention.

The present disclosure is directed to materials with particularly useful properties in climate control methods and systems, as well as to methods for making such materials, and apparatus and systems using such materials. These include climate control units which may be used for cooling such as in a climate control system for air conditioning a space such as a room, removing heat from equipment or device such as a computer system or creating a climate for a food storage unit.

Although various materials may be used in the methods and systems described herein, the applicant has discovered certain materials that are particularly effective for climate control through evaporative cooling. With reference to FIG. 21, the materials used in and made in certain embodiments of the present invention may be a ceramic mixture 512 comprising clay 502 and carbon 504, or of clay 502, carbon 504 and a metal 508, which metal 508, it has been found advantageous, may be aluminum. Such materials provide an efficient and effective cooling media when used to make a ceramic object 516 of the present invention ceramic object 516, particularly under conditions of relative humidity greater than 45%. The ceramic mixture 512 may optionally comprise additional components as well.

The clay 502 used in the material may be any porous clay suitable for use in making a ceramic mixture 512, which is thereafter shaped 574 and then fired 570 (heated for a period of time) to create a ceramic object 516. Kaolin clay may be a particularly useful clay 502 in various embodiments. Kaolin clay is a naturally occurring material, sometimes referred to as hydrated aluminum silicate, and generally having the chemical composition Al₂Si₂O₅(OH)₄, or may be synthesized. Depending upon its source and how it is processed, kaolin clay may have relatively larger or smaller particle sizes and may further include other minerals such as iron oxide. Any of these various types of kaolin clay may be used in embodiments of the inventions. Kaolin clay provides porosity, high surface area when needle mullites form during firing, water holding capacity, high emissivity (the ratio of the energy radiated from a material's surface to that radiated from a blackbody at the same temperature and wavelength and under the same viewing conditions), and thermal mass to the ceramic object 516, while also acting as a bonding agent.

The material further comprises carbon 504. The carbon 504 provides additional surface area, porosity, water holding capacity, high emissivity and thermal mass to the ceramic object 516. The carbon 504 may also act as an adsorbent. These attributes are described further below. In some embodiments, the carbon 504 is activated carbon 514 which may be particularly useful because of the high surface area that activated carbon 514 provides, thereby increasing the evaporation and condensation, which is a surface phenomenon. The activated carbon 514 absorbs heat and water vapor from the environment. The activated carbon 514 may be produced from organic material 518, by burning or oxidizing the organic material 518 in an activation 560 process to form charcoal, as activated carbon 514. For example, organic material 518 such as wood may be put through pyrolysis to make charcoal as activated carbon 514, such as through pyrolysis in a kiln. The pyrolyzed organic material, as activated carbon 514, may then be mechanically reduced in size to a powder, such as by grinding. The powder particles may have a size of approximately 0.125 mm, such as that which fits through standard 120 mesh. This powder of activated carbon 514 may then be heated 562 again to a high temperature, such as to a temperature between about 800° C. and about 1300° C., after which steam may be introduced to initialize the activation. If steam is to be introduced into the firing 570 process of the composite ceramic mixture 512, then when the ceramic mixture 512 reaches the desired temperatures of 1100° C. to 1300° C., steam is added to the crucible to fracture the composite matrix by activating the carbon a second time while in the material matrix and by inducing shock contraction in the overall matrix. After 2 to 10 hours of partial oxygen 520 exposure, water is used to force-cool the still-combusting mass of the ceramic mixture 512 to ambient temperature. This process creates more surface area in the material.

This process may be performed in a kiln or other suitable equipment, as will be understood by one of skill in the art. In some embodiments of the present invention, the activated carbon 514 may be mixed 544 with a starch 506, which may be cassava starch or another, prior to activation 560, at a ratio by weight of 0.5% to 10% of liquid and viscous warm starch 506. This binds the carbon 504 for better handling during the activation 560 process. The starch 506 carbonizes during the activation 560 process and becomes finer activated carbon 514 particles.

Carbon 504 appears to be highly effective in the cooling ceramic objects 516 of the present invention for one or more of several reasons. Activated carbon 514 has a very high surface area per unit of mass. Evaporation may be easier from the surface of carbon 504 or activated carbon 514 because it does not diffuse with the water being evaporated. Because the water sits on the surface of the carbon 504 or activated carbon 514 particles, which may effectively be pores in the ceramic object 516 of an exemplary climate control unit 10, the water does not need to become unbound from the carbon 504 or activated carbon 514 prior to evaporation. In addition, the numerous pores in the carbon 504 or activated carbon 514 may provide for high water holding capacity. Water held in any such carbon 504 or activated carbon 514 pores in the ceramic object 516 may be insulated from the temperature of the ambient environment because air pockets and the carbon 504 or activated carbon 514 pores keep the water cooler than the ambient air. The carbon 504 or activated carbon 514 pores therefore may provide a thermal shield from ambient conditions, maintaining a zone of low pressure in the ceramic object 516 of a climate control unit 10. In addition, the carbon 504 or activated carbon 514 may act as a blackbody providing blackbody absorption and emissivity, and absorbing and radiating heat at a maximum emissivity at or approaching 1. It is further noted that carbon 504 or activated carbon 514 is highly effective at storing heat because of its heat capacity, such that it can act as a reservoir of thermal energy. The colder the mass, the higher the temperature difference between the air and the mass and the higher the cooling capacity.

The ceramic material may also further include a metal 508, which, it has been found advantageous, may be aluminum. Because the ceramic mixture 512 may be shaped 574 before firing 570 to maximize its surface area after being fired 570 as a ceramic object 516, which increased surface area is to increase evaporation, it has been found advantageous to include 550 aluminum or another metal 508 in the ceramic mixture 512 for several reasons. Including 550 aluminum or another metal 508 in the ceramic mixture 512 may add thermal conductivity, increasing the rate of heat transfer. Aluminum or another metal 508 in the ceramic mixture 512 may act as an antibacterial agent to reduce bacterial growth, not only for when an exemplary ceramic object 516 is used as a container for potable water, but also in other embodiments of the present invention in which the water contacting the ceramic object 516 is a component of the air stream, that is, the air flowing near, across, over, or through a climate control unit or other embodiment of a ceramic object 516 of the present invention. In addition, the size of aluminum particles or particles of any metal 508 and the quantity of metal 508 included in the ceramic mixture 512 may be manipulated or altered to control, or calibrate, the porosity of the ceramic mixture 512 and thus of the exemplary ceramic object 516. For example, in some embodiments the aluminum or another metal 508 in the ceramic mixture 512 may be used to increase the porosity of the ceramic object 516. Aluminum or another metal 508 may also be useful in the ceramic object 516 due to the reflective property of the aluminum or another metal 508, which can cause the ceramic object 516 to absorbs less heat from the ambient environment, enabling a higher temperature difference between the ceramic object 516 and the ambient air.

The aluminum or another metal 508 used in various embodiments may be particles of aluminum or another metal 508 of any size, including but not limited to powder, dust, shavings, or pellets, and may be gathered as a byproduct from other manufacturing processes using aluminum or another metal 508.

In some embodiments, the ceramic mixture 512 may be strengthened by firing 570 it at a high temperature such as about 1300° C. to achieve greater strength, in particular to achieve greater strength from the kaolin or other clay 502 component and to produce needle mullites. Needle mullites are a form of a silicate mineral that can be created when ceramics are fired 570 under certain conditions, and which is a refractory mineral: one that is resistant to decomposition by heat, pressure, or chemical attack, adding to the mechanical strength of the ceramic. Needle mullites also have a high aspect ratio, which expands the effective surface area of the ceramic object 516 that is available for absorption and evaporation of water, making the evaporative cooling of the climate control units of the present invention more effective and efficient.

The components of the climate control material may be combined in various ways such as by mixing 530 or kneading them together. In some embodiments of the present invention, the dry activated carbon 514 powder is mixed 530 with the clay 502, such as kaolin, and any other ingredients that may optionally be included, along with water 510 which may, it has been found advantageous, be cold water, to form the ceramic mixture 512. This ceramic mixture 512 may be shaped 574 into a shaped ceramic mixture 512 of the form of the desired ceramic object 516 by molding such as molding, slip casting, compression molding or by dry compression casting, for example.

The proportions of the components may vary. For example, in embodiments comprising clay 502 and carbon 504, or comprising clay 502 and activated carbon 514, the clay 502 such as kaolin clay may be between about 90% and 40% of the ceramic mixture 512 by weight, or may be between about 40% and about 50% of the ceramic mixture 512 by weight, and the carbon 504 or activated carbon 514 may be between about 10% and 60% of the ceramic mixture 512 by weight.

The ceramic mixture 512 may be shaped 574 into any desired shape in which a finished ceramic object 516 may be useful for climate control, such as rocks, tubes, or a water-holding vessel. Once in the desired shape, the ceramic mixture 512 may be fired 570 to a high temperature using a kiln or other appropriate device. For example, the ceramic mixture 512 may be fired 570 at a temperature of about 800° C. to about 1300° C.

The shaped ceramic mixture 512 may be bleached 572, prior to being fired 570, by exposing the ceramic mixture 512 to oxygen 520 at temperatures from 1050° C. to 1300° C. Such bleaching 572 may increase the surface area of each rock, or other exemplary shape of the shaped ceramic mixture 512, by removing the combustible carbon particles on the surface of the shaped ceramic mixture 512, such that the vacant pores on the surface are populated with mullites and needle mullites when the kaolin clay component reaches temperatures above 1050° C. or up to or above 1300° C. The added surface area increases the amount of water that can be evaporated or vapour that can be condensed, which added surface area may result in more climate control or heat removal capacity for the climate control unit 10 made from the ceramic mixture 512 of the present invention.

In one example of a ceramic mixture 512 comprising carbon 504 and clay 502, including but not limited to kaolin clay 502, the ceramic mixture 512 may be made as follows: mix the kaolin clay 502 and activated carbon 514 while both materials are dry; then add water 510 onto the dry materials forming a wet ceramic mixture 512; and either use the wet ceramic mixture 512 immediately, or leave the wet ceramic mixture 512 of such materials wrapped for approximately a few days to allow the moisture 510 to permeate the mixture of such materials until a final semi-plastic consistency is achieved. The final ceramic mixture 512 can be extruded, moulded, casted, sculpted, and/or incised. The ceramic mixture 512 may then be fired 570 in a kiln to obtain the final ceramic product, such as a plurality of ceramic objects 516.

In an example of a ceramic mixture 512 comprising carbon 504 or activated carbon 514, clay 502 such as kaolin clay 502, and aluminum or another metal 508, the ceramic mixture 512 may be made as follows: mix the kaolin clay 502 and activated carbon 514 and aluminum or another metal 508 while dry to form a dry ceramic mixture 512; then mix cold water 510 into the above dry ceramic mixture 512 and allow the water 510 to react with the aluminum or another metal 508 to release hydrogen and form aluminum oxide or an oxide of the other metal 508; then leave the above ceramic mixture 512 to dry; then crush the dried ceramic mixture 512 and leave it exposed to air for approximately a few days to absorb moisture from air until a desired consistency is achieved, such as a semi-dry consistency. The final ceramic mixture 512 can be extruded, moulded, casted, sculpted, and/or incised. The ceramic mixture 512 may then be fired 570 in a kiln to obtain a plurality of ceramic objects 516 of the present invention.

The ceramic mixture 512 used for climate control according to various embodiments may be a porous material like those described above, or may be a ceramic mixture 512 comprising carbon 504 and other porous material. The ceramic mixture 512 may have a porosity—meaning the void spaces in the material, expressed as a percentage or fraction of the volume of voids over the total volume—of between about 20 to 75 percent, such as about 25 to 45 percent, or about 45 to 75 percent. In some embodiments, the ceramic mixture 512 is a composition as described above including clay 502, such as kaolin clay 502, carbon 504 such as activated carbon 514, with or without aluminum or another metal 508, and has a porosity of between about 25 to about 75 percent, such as between about 45 to 75 percent. In some such embodiments, the porosity of the ceramic mixture 512 can be adjusted by increasing or decreasing the amount of carbon 504 in the ceramic mixture 512 or in the case of ceramic mixtures 512 with aluminum or another metal 508, by adding aluminum or another metal 508 of 10%-30% of the volume or weight of the ceramic mixture 512. Alternatively or additionally, the porosity and surface area of the ceramic mixture 512 can also be adjusted by increasing or decreasing the temperature at which the ceramic mixture 512 is fired 570, and/or the time for which the ceramic mixture 512 is fired 570. For example, firing the material at temperatures of about 1150° C., or between about 1050° C. and about 1300° C., may be used to increase the size of the surface area of the kaolin clay 502 component of the ceramic mixture 512, and to calcinate much of the kaolin clay 502, such as through the formation of mullite minerals and interlocking of the mullite mineral formations.

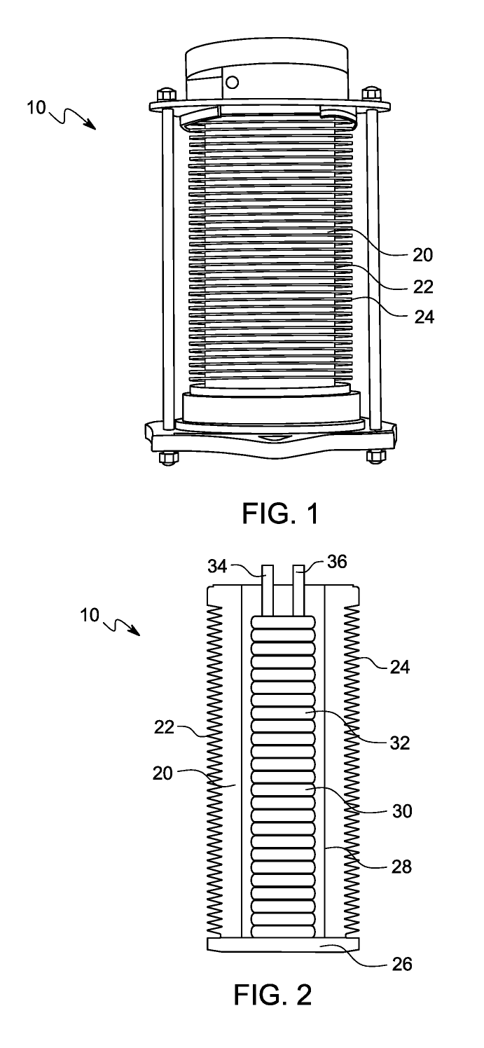

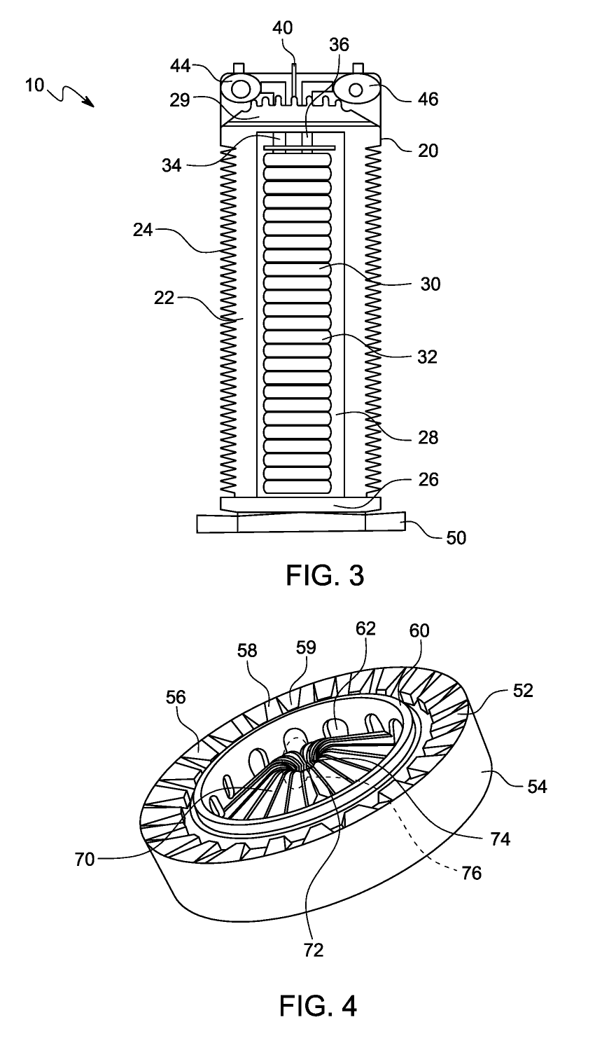

In some embodiments, with reference to FIG. 1, FIG. 2, and FIG. 3, the material is made into a ceramic chamber 20 for holding water. With a thermal energy production approximating about 40.8 KJ/mol from latent heat during evaporation or condensation, water produces a significant temperature decrease or increase when it evaporates or condenses. Because of the porous nature of the ceramic material, water held within the chamber 20 may soak through the walls of the chamber 20 and evaporate into the air surrounding the chamber 20, causing the desired climate control of the air around the chamber 20, as well as of the walls of the chamber 20 themselves and of the water or mass within the chamber 20 due to the thermal conductivity of water and the mass of the chamber 20. In addition, it is believed that the use of water as the evaporative media adds to the emissivity of the body and, similar to carbon and kaolin, can serve as a thermal mass for heat storage. Activated carbon in the mass may absorb water vapor and heat from the environment resulting in the effective dehumidification of the air and cooling of the environment.

One example of a chamber 20 which may be used for climate control is shown in FIG. 1, in which the chamber 20 is a component of a climate control unit 10. While the chamber 20 (and the other exemplary chambers described or shown in the present disclosure) may be made of a climate control material as described above, it may alternatively be made of a different porous material. In the embodiment shown in FIGS. 1-3, the chamber 20 is approximately cylindrical, though it may alternatively have a cross-sectional shape which is not round but rather is oval, square or any other shape. The chamber 20 includes an outer wall 22 from which a plurality of fins 24 project outward, approximately perpendicular to the long axis of the chamber 20, along some or all of the length of the outer wall 22, thereby increasing the outer surface area of the chamber 20 to maximize the surface area from which the water can evaporate. Although it cannot be seen in FIG. 1, which provides an outside view of the climate control unit 10, the chamber 20 is hollow within and closed on the bottom. The chamber 20 may be open at the top and may be used with a lid which may include openings through which pipes, gages, etc. may pass into the chamber 20. In some embodiments, the lid may be airtight when in place on the chamber 20. The chamber 20 may be a various heights and widths, depending upon its ultimate use. The chamber 20 may contain, in some embodiments of the present invention, a coil container 28, which coil container 28 may contain a plurality of coils 30, comprising one or more individual coils 32, which a plurality of coils 30 may transport water, or another fluid, for use as a refrigerant to be pumped in or out of the chamber 20, or may be used to supply water to the outer wall 22 of the chamber 20. The chamber 20 may comprise, at bottom, a bottom lid 26, which may be situated over a water collector 50. In some embodiments of the present invention, the plurality of coils 30 may be supplied by an intake pipe 34 and the water or fluid may be removed via an outtake pipe 36, which intake pipe 34 and outtake pipe 36 traverse a chamber lid 29. The intake pipe 34 may have water or fluid supplied or pushed by an intake valve 44, and the outtake pipe 36 may have water or fluid supplied or pushed by an outtake valve 46. The chamber 20 may also be fitted with a sensor fitting 40, which may be used to mount a thermocouple, hygrometer, or other instrument, as will be understood by one of skill in the art.

The fins 24 which encircle the chamber 20 provide increased surface area for evaporation of water and heat and vapor absorption from the outer surface of the chamber 20. Because of this, the fins 24 may cover the entire outer wall 22 of the chamber 20 or substantially all of the outer wall 22 of the chamber 20, though they may optionally cover less of the outer wall 22 in some embodiments. The dimensions of the fins 24 may vary depending upon the size of the chamber 20, the material from which it is made, and the ultimate use of the chamber 20, for example. However, since the purpose of the fins 24 is to increase surface area, the fins 24 may extend radially outward as far as the water is able to migrate through the material, which will depend upon the porosity of the material. Similarly, to maximize surface area, the fins 24 may be as thin as possible, depending upon the strength and fragility of the material. In some embodiments, the fins 24 extend between about 1 cm and 4 cm, or it has been found advantageous between about 2 cm and 3 cm, radially outward from the surface of the outer wall 22, that is, from what would be the outermost extent of the outer wall 22 were it not for the fins 24. The fins may be between about 3.5 mm and about 10 mm thick, or it has been found advantageous, between about 5 mm and about 10 mm thick, measured at the outer edge or at the connection to the outer wall 22. As such the fins 24 are thin as compared to how far they extend outward. While the actual dimensions of the fins 24 might vary, particularly depending upon the size of the chamber 20 with which they are used, a similar ratio of length (of extension of the fins 24 from where they attach to the outer wall 22) to width (of each of the plurality of fins 24 at the connection to the outer wall 22) may be used. This ratio may be about between about 1.5 and about 8, or it has been found advantageous, between about 2.5 and about 6, or between about 3.5 and 4.5. Relative to the outside wall of an identical chamber 20 without fins 24, the surface area of the chamber 20 including fins 24 may be increased by about 2 times, 3 times, 4 times, or 5 times. In some embodiments, the surface area may be increased by between about 3 times and 5 times by the presence of the fins 24. These dimensions may vary proportionally for varying sizes of the vessels.

As air flows past the chamber 20, water within the chamber 20 evaporates through the outer wall 22 and the fins 24, cooling the air around the chamber 20 as well as the container itself (such as the fins 24 and outer wall 22) which in turn cools the water within the chamber 20. The more evaporation that occurs, the greater the cooling.

In some embodiments, the chamber 20 may simply be filled with water and may be used for cooling the ambient air, while in other embodiments the cooling of the water within the chamber 20 may be used for additional cooling of a refrigeration chamber for example.

An example of a water collector 50 is shown in FIG. 4. The water collector 50 may sit under an exemplary climate control unit 10, and collects the water that passes through the outer wall 22 and fins 24 of the chamber 20 but which does not evaporate but which rather runs downward and drips off of the chamber 20. In addition, humid air may condense on the cold surface of the chamber 20. The hydroscopic properties of the chamber material may attract moisture from the environment to it and this moisture may condense on contact with chamber. This may create active condensation which adds to the water running off into the water collector.

The water collector 50 may include an aperture 76 for the outflow of collected water. The aperture may be in the bottom of the water collector 50, such as beneath the center 74 of the inner portion 70 of the water collector 50. The aperture may connect to an outflow system such as tubing and optionally one or more fluid pumps to return the collected water to the chamber 20 for reuse in evaporation, for reuse in an alternative use, or for outflow to a drain. The water collector 50 may also comprise an outer wall 54, inner ribs 72, an inner wall 60, a plurality of inner wall openings 62, and a plurality of outer wall 54 top surfaces 52, 56, and 59, and a plurality of outer wall 54 indentations 58.

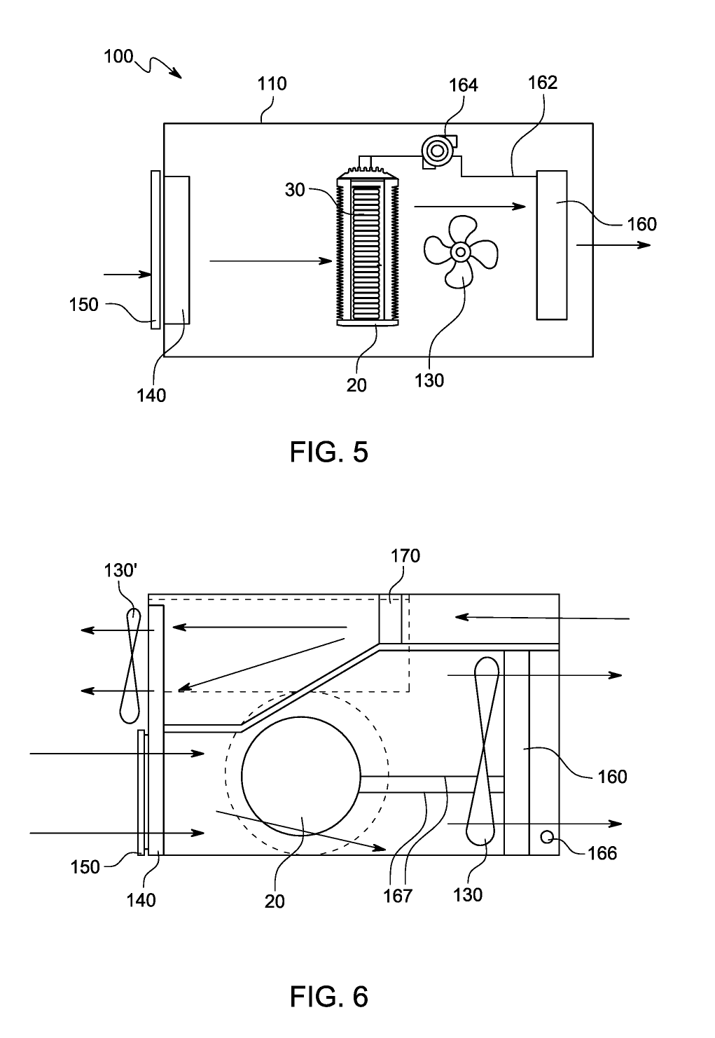

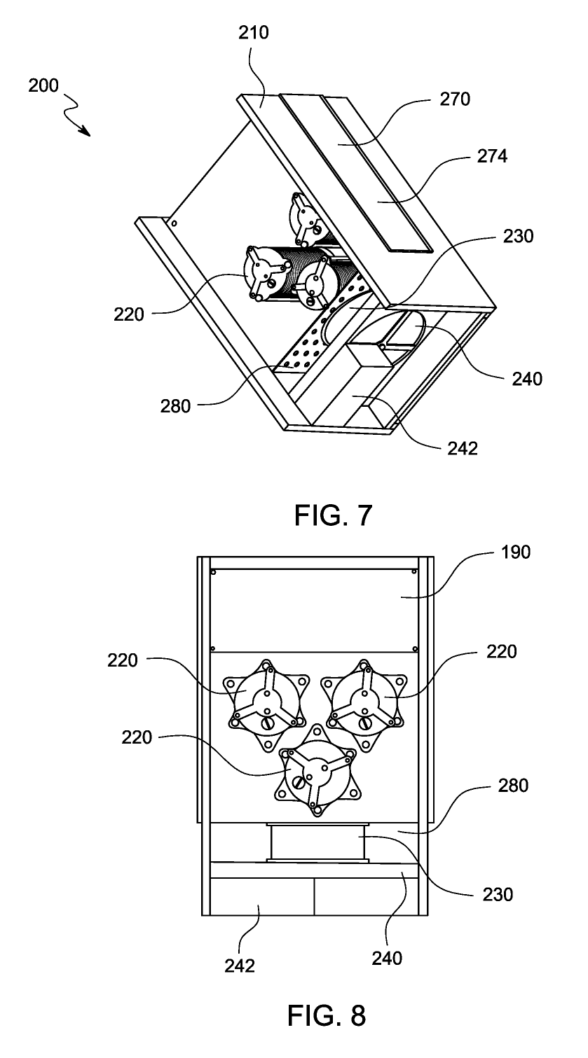

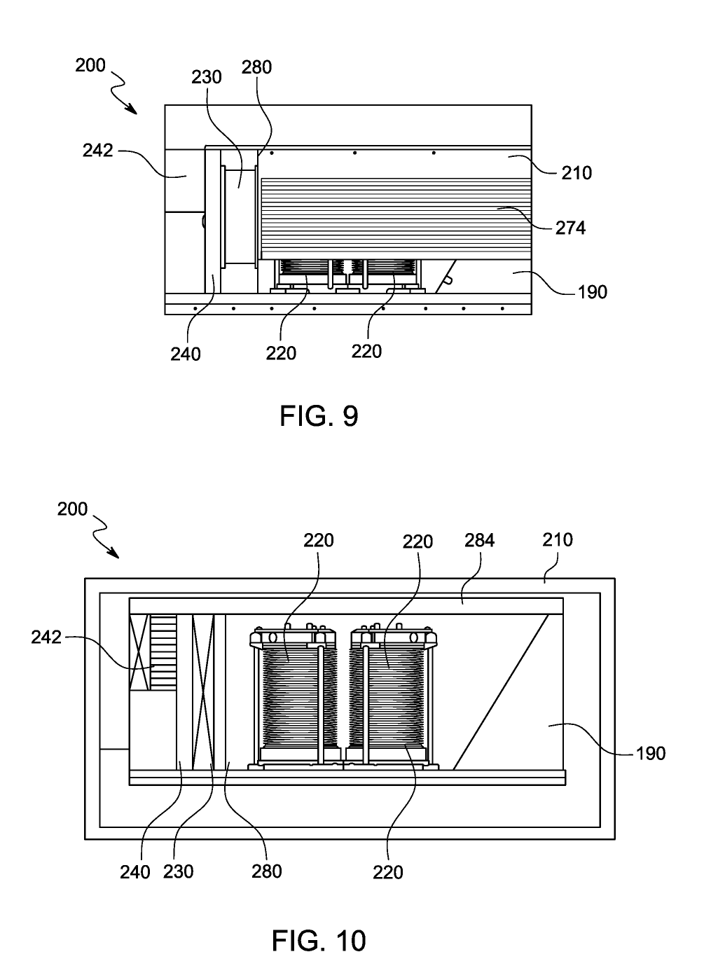

The climate control units 10 as described herein may be used as components of climate control systems 100 to provide cooling. This cooling may be environmental, such as to cool an indoor or outdoor living space or an equipment room in the fashion of heat removal for improved comfort and/or equipment function. Alternatively, the cooling provided by the systems 100 may be for preservation, such as preservation of food or other degradable materials, in the manner of refrigeration. With reference to FIGS. 5-10, such a climate control system 100 may comprise a housing 110 containing a plurality of climate control chambers 20, an air inlet 150, an air control unit 140, a fan 130, a refrigerant supply pump 164, a refrigerant supply line 162, and a heat exchanger 160. Such a climate control system 100 may further comprise a second fan 130′ and a drainage line 167, and may comprise a plurality of chambers 220.

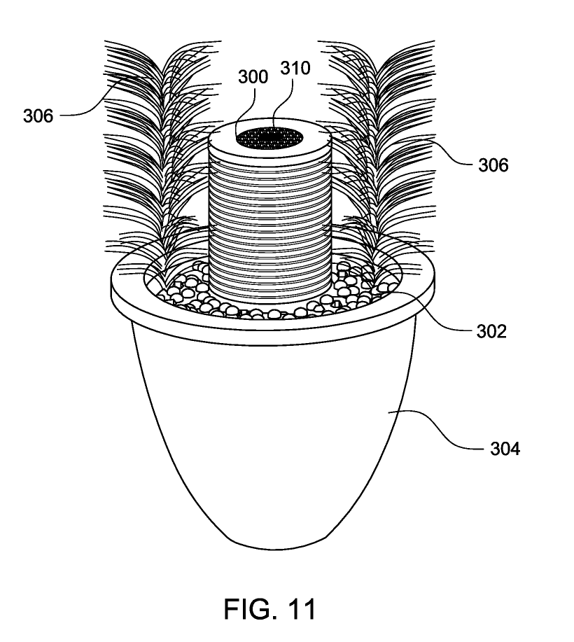

In still other embodiments of climate control units 300 described herein, the climate control units 300 may be incorporated into potted plants as shown, for example, in the embodiments depicted in FIGS. 11-15, or may of course be situated in other environs. In such embodiments, the climate control units 300 may sit on top of the soil, surrounded by the plant, or the bottom of the climate control units 300 may be partially buried within the soil.

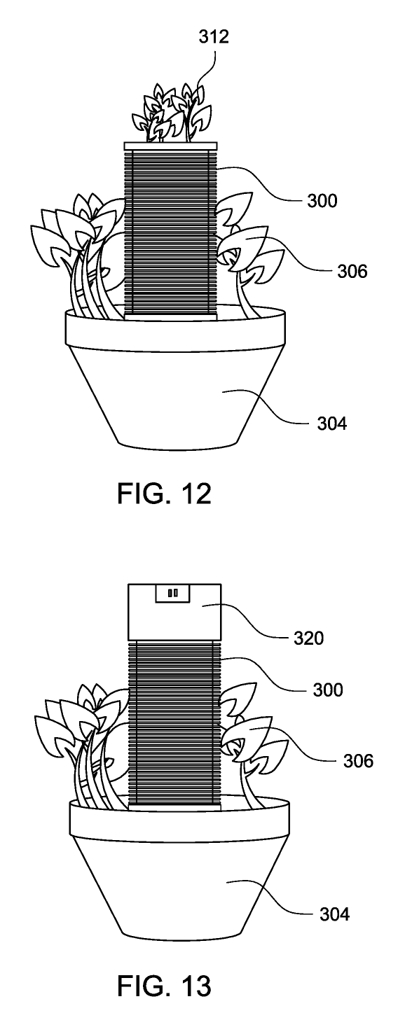

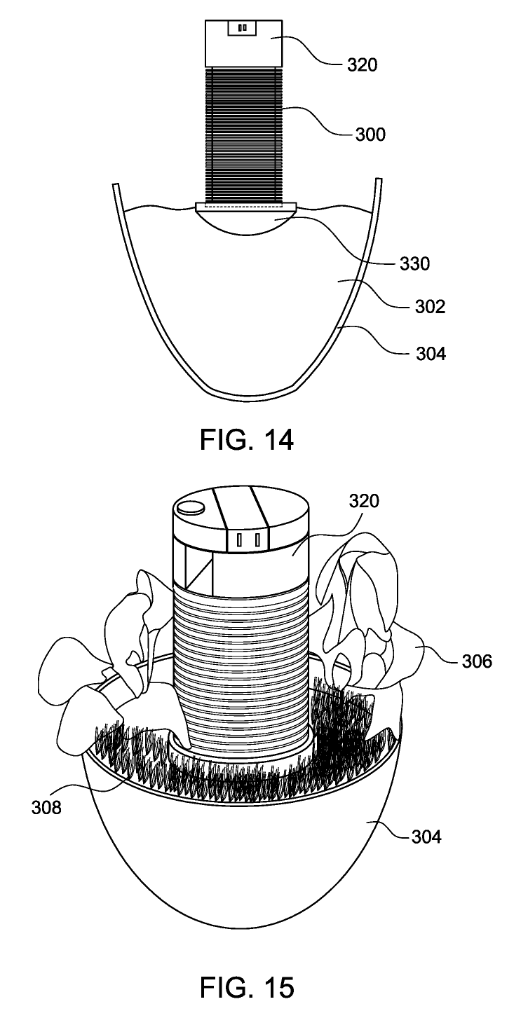

FIG. 11 depicts a climate control unit 300 sitting on top of the growing medium 302, which growing medium 302 may be dirt or any other plant growing medium, and within an open topped container 304 suitable for plants 306. Such containers may be traditional such as a ceramic or plastic pots with drainage holes at the bottom. The exemplary climate control unit 300 is centrally located, surrounded by a plurality of live growing plants 306. The surrounding plants 306 may visually obscure the climate control unit 300 and, if they are real plants 306 (as opposed to plastic plants 306 which may also be used), they may naturally respire and filter the air, improving air quality. The climate control unit 300 is like those described previously herein. However, in this embodiment the center of the climate control unit 300 may be filled with water, or with sand 310 and water. In embodiments in which sand 310 is used, the sand may help regulate the discharge of water by absorbing some of the pressure of the water from gravity and may also provide heat storage. In FIG. 12, the exemplary climate control unit 300 is shown with a small plant 312 planted in it, to provide additional visual cover for the climate control units 300, and the other heath benefits of having plants 312 and plants 306 in an environment. The embodiment shown in FIG. 13 is likewise similar, with a climate control unit 300 that may be filled with water, or with a combination of water and sand 310, but the top of the climate control unit has been modified to include an illuminated water tank and battery pack 320 at the top which may be used for charging small portable devices such as portable phones and tablets and may be charged by a solar panel, not shown as part of the present disclosure. The embodiment shown in FIG. 14 is similar to that shown in FIG. 13 but is shown in cross section and without the surrounding plant (though it may also be used with a plant). In this embodiment, the climate control unit 300 is sitting on the plant growth medium 302 such as dirt and includes a base 330 which is rounded and recessed into the plant growth medium 302, such that the climate control unit 300 can be used in a tilted position away from vertical as desired by a user with the plant growth medium 302 providing support and prevent the climate control unit 300 from tipping over. This embodiment also includes the illuminated water tank and battery pack 320 at the top of the climate control unit. FIG. 15 is an image of an embodiment like that shown in FIG. 14, including a climate control unit 300 with an illuminated water tank and battery pack 320 surrounded by a plurality of live plants 306 as well as grass 308 growing in the plant growth medium 302. The illuminated water tank and battery pack 320 may include a light, water storage for refilling the climate control unit, and/or a battery which may be rechargeable. In some embodiments, the climate control units 300 may include features such as motion detectors to activate the light when someone is present in the room and/or a dimmable light controlled remotely by a smart phone or tablet app or computer through WiFi, Bluetooth or other remote communication methods.

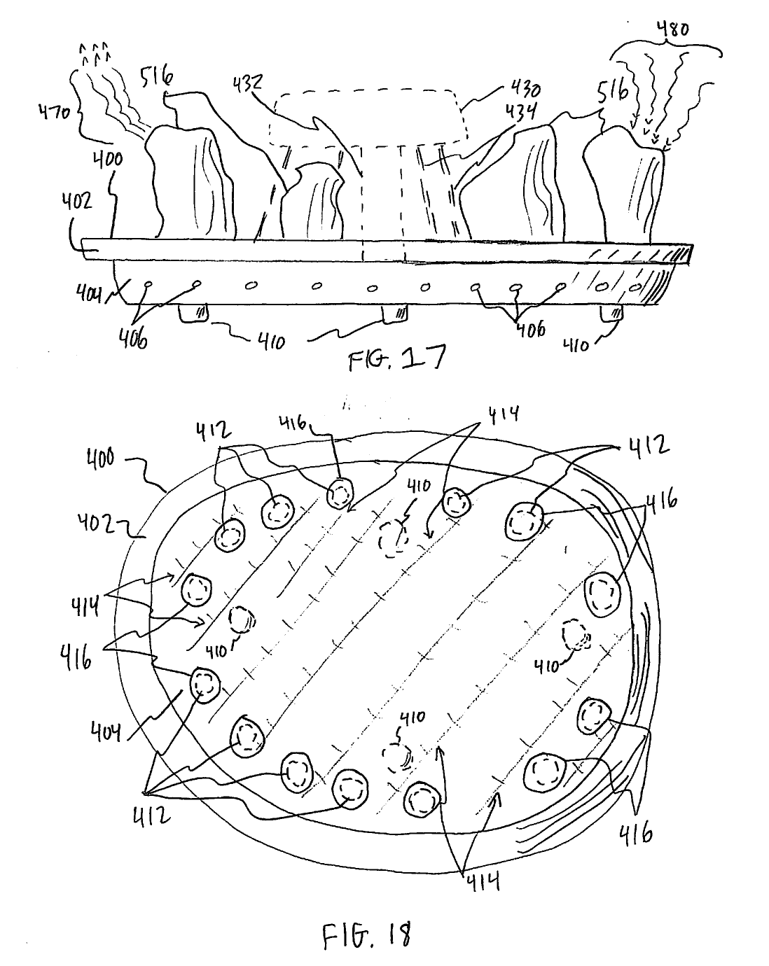

With reference to FIGS. 17-20, another embodiment of the present invention is disclosed. In this embodiment, a plurality of ceramic object 516 of the present invention are placed on or attached to a tray 400, which tray is intended for climate control through evaporative cooling or condensing heating. The tray 400 may comprise components made with wood, ceramics, or metals, or other materials now known or later invented, as will be understood by one of skill in the art. The tray 400 may comprise a single unit with a concave depression or lower area disposed approximately in or near the middle of the tray 400. Alternatively, the tray 400 may comprise one or more components, including but not limited to a tray rim 402 and a tray bottom 404, which arrangement creates a similar depression or lower area approximately in or near the middle of the tray 400, here, in part or all of the tray bottom 404. The tray 400 is, it has been found advantageous, sized and disposed so as to contain, when placed with the concave depression pointing up, up to approximately 5 mm of water 440 as measured in depth, and a plurality of ceramic objects 516, such that the plurality of ceramic objects 516 draw water 440 up to the surface of the plurality of ceramic objects 516 by capillary action, also referred to as capillary force, from which plurality of ceramic objects 516 the water 440 may and does evaporate 470. Vapour from the ambient air stream may condense 480 on the surfaces of the plurality of ceramic objects 516 in the tray 400. The tray 400 may comprise side air inlets 406 of approximately 0.5 mm to approximately 2 cm, or any other appropriate dimensions as will be understood by one of skill in the art, placed in a circular formation, or other appropriate formation that allows airflow and circulation of ambient air from around the tray 400 into the concave depression area of the tray 400 and thus around and over the plurality of ceramic objects 516. The side air inlets 406 are placed around the tray 400, or on the tray bottom 404 in embodiments comprising the tray bottom 404. Around the tray 400, the side air inlets 406 may be spaced between about 1 cm and about 6 cm apart from each other. The side air inlets 406 may, it has been found advantageous, be about 0.5 cm to about 3 cm in diameter in the outer surface of the tray 400, and may taper to about 0.3 cm to about 2 cm in diameter in the inner surface of the tray 400. The side air inlets 406 allow compressed air, or uncompressed ambient air, to flow into the tray 400.

The tray 400 may further comprise bottom air inlets 412, which allow airflow and circulation of ambient air from underneath the tray 400 into the concave depression area of the tray 400 and thus around and over the plurality of ceramic objects 516. Where the tray 400 comprises bottom air inlets 412, the tray 400 also comprises retainer insertions 416 set above and around the bottom air inlets 412, inside the tray 400, such that an air stream from below the tray 400 can flow into and over the plurality of ceramic objects 516 in the tray 400, from beneath the tray 400, without allowing the water 440 to flow through the bottom air inlets 412 and out of the tray 400. The retainer insertions 416, which are affixed to the interior of the tray 400, rise approximately 5 mm to approximately 7 mm from the interior of the base of the tray 400; which elevation range of the retainer insertions 416 is high enough to be higher than the recommended depth of the water 440 in the tray 400, so that the water 440 will not flow out of the tray 400 by exceeding the height of the retainer insertions 416 surrounding the bottom air inlets 412.

The tray 400 may be placed on a stand, which may be wooden, metal, composite, or made of another material, such that the tray 400 is, it has been found advantageous, at a height of about 12 cm to about 100 cm. The tray 400 may further comprise placement studs 410 disposed on and fixedly attached to the underside of the tray 400, to assist with aligning the tray 400 with any stand and assisting in retaining the tray 400 on the stand. Alternatively, the placement studs 410 may serve as feet to support the tray 400 if placed on a flat surface, and to allow air to circulate under the tray 400 and in through the bottom air inlets 412, where the tray 400 comprises any such bottom air inlets 412.

The tray 400 may further comprise a mesh 414, which mesh 414 may be removably affixed to the top of the tray 400. The goal of affixing the mesh 414 is to prevent the plurality of ceramic objects 516 from falling off the tray 400, and also for embellishment. The mesh 414 may comprise any waterproof material, such that the mesh 414 is not destroyed or damaged by contact with or proximity to the water 440 in the tray 400.

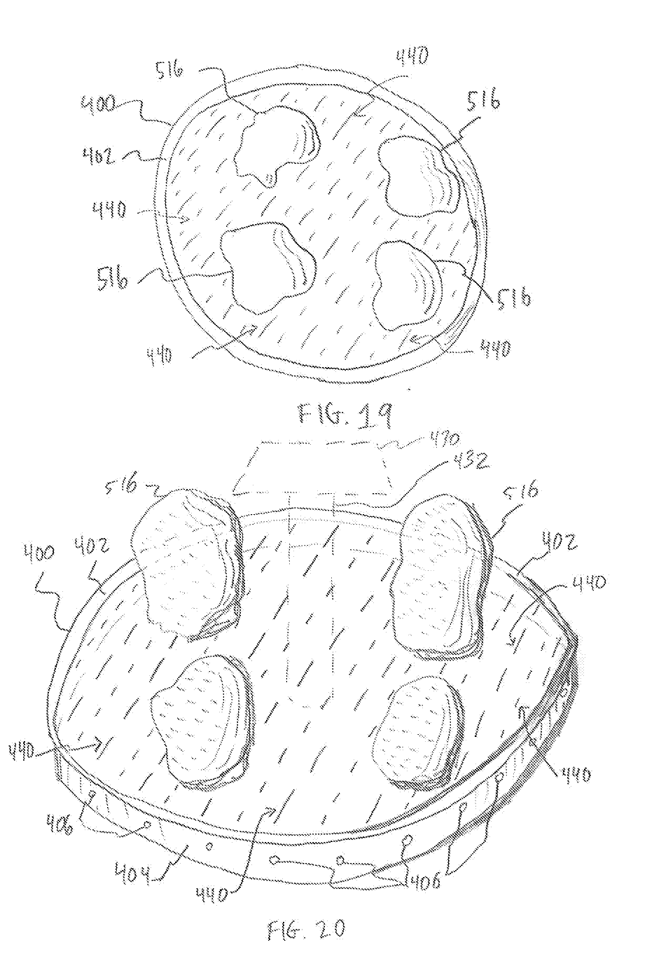

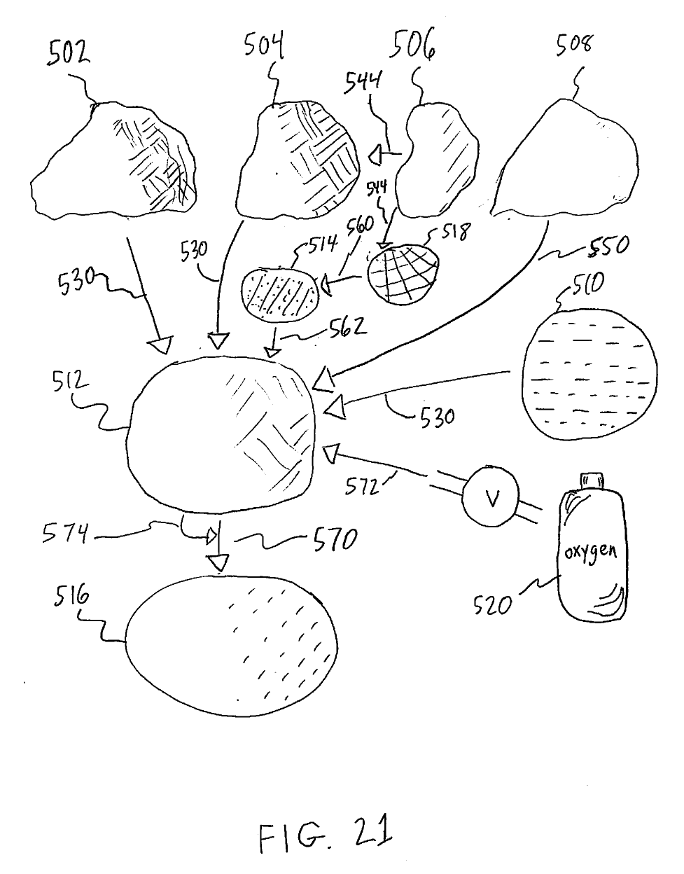

The tray 400 may be used in conjunction with one or more components intended to increase airflow across and in the tray 400, and/or to raise the temperature local to the immediate environment of the tray 400, thus increasing the evaporative cooling and climate control effect of the present invention by increasing transport of water 440 into and through the plurality of ceramic objects 516. The tray may be used in conjunction with a lamp 430, which lamp 430 may be mounted on a lamppost 432 affixed to the tray 400, as shown in FIG. 17 and FIG. 20, or which lamp 430 may be external to the tray 400. The light 434 from the lamp 430 may be used for lighting the environment of the tray 400 in general, which has uses for a user of the tray 400 in general, as will be understood by one of skill in the art, and which may also drive the evaporative cooling of the tray 400 of the present invention, by heating the water 440, the air surrounding the tray 400, and by causing the air in the vicinity of the tray 400 to circulate, breaking up the surface layers of air surrounding the plurality of ceramic objects 516 and allowing further evaporative cooling, among other possible mechanisms. In some embodiments of the present invention, a fan may be placed under or to the side of the tray 400, to drive airflow into and/or across the tray 400. The airflow accelerates evaporation and condensation, therefore leading to stronger climate control effect by cooling and dehumidification.

### EXPERIMENTAL RESULTS

### Example 1

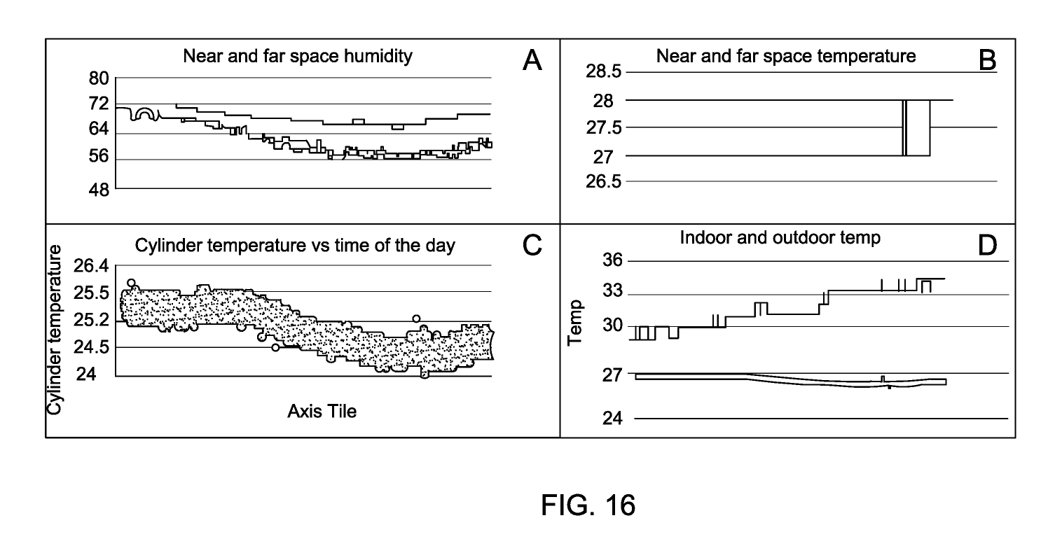

With reference to FIG. 16, a series of compositions were created that comprised carbon 504 or activated carbon 514 and kaolin clay 502, as well as some compositions that also comprise aluminum or another metal 508. The carbon 504, in some of the compositions of matter, activated carbon 514 made from burning hard wood as described previously in this application. The aluminum or another metal 508 was sourced as aluminum dust. The relative amounts of carbon 504, kaolin clay 502, and aluminum or another metal 508 are shown in Tables 2-5 below. The compositions, being ceramic mixtures 512 were shaped 574 into vessels measuring approximate 6 inches by 11 inches. The vessels were fired 570 to 850° C.

The vessels were filled with cool water and an air current was applied to the vessels using a fan at a wind speed of 12.6 km/hr. The environmental conditions of temperature and humidity varied and are shown in the tables below. The air temperature adjacent to the vessels was measured after 5 minutes and after 15 minutes. In each case, there was a significant reduction in air temperature, as shown in Tables 2-5.

TABLE 2

| | | Ambient | Temp (° C.) | Temp (° C.) |
|---|---|---|---|---|
| Composition % | | Temp | after 5 | after 15 |
| (carbon/kaolin/Al) | Humidity | (° C.) | minutes | minutes |
| 30/60/10 | 47.2 | 34.5 | 27.6 | 25.5 |
| 30/60/10 | 47.2 | 34.5 | 26.9 | 25.2 |
| 30/60/10 | 47.2 | 34.5 | 26.3 | 25.2 |
| 40/50/10 | 46.5 | 34.5 | 27.6 | 25.6 |
| 40/50/10 | 46.5 | 34.5 | 26.9 | 25.3 |
| 40/50/10 | 46.5 | 34.5 | 26.4 | 25.4 |
| 30/50/20 | 46.6 | 34.5 | 27.6 | 25.7 |
| 30/50/20 | 46.6 | 34.5 | 27.0 | 25.5 |
| 30/50/20 | 46.6 | 34.5 | 26.5 | 25.5 |
| 40/60/20 | | 34.5 | 27.7 | 25.9 |
| 40/60/20 | | 34.5 | 27.0 | 25.3 |
| 40/60/20 | | 34.5 | 26.4 | 25.3 |

Initial water temperature 32.2° C. Dew point 22.0° C. Wet bulb 25.6° C.

TABLE 3

| | | Ambient | Temp (° C.) | Temp (° C.) |
|---|---|---|---|---|
| Composition % | | Temp | after 5 | after 15 |
| (carbon/kaolin/Al) | Humidity | (° C.) | minutes | minutes |
| 50/40/10 | 57.7 | 33.7 | 28.2 | 26.9 |
| 50/40/10 | 57.7 | 33.7 | 27.8 | 26.8 |
| 50/40/10 | 57.7 | 33.7 | 27.3 | 26.7 |
| 40/30/10 | 58.2 | 33.7 | 27.7 | 26.6 |
| 40/30/10 | 58.2 | 33.7 | 27.2 | 26.6 |
| 40/30/10 | 58.2 | 33.7 | 26.8 | 26.7 |
| 50/50 | 60.5 | 33.7 | 27.8 | 26.7 |
| 50/50 | 60.5 | 33.7 | 27.3 | 26.7 |
| 50/50 | 60.5 | 33.7 | 26.9 | 26.8 |

Initial water temperature 30.7° C. Dew point 23.8° C. Wet bulb 26.5° C.

TABLE 4

| | | Ambient | Temp (° C.) | Temp (° C.) |
|---|---|---|---|---|
| Composition % | | Temp | after 5 | after 15 |
| (carbon/kaolin/Al) | Humidity | (° C.) | minutes | minutes |
| 60/40 | 59.0 | 33.2 | 28.6 | 27.1 |
| 60/40 | 59.0 | 33.2 | 27.9 | 26.6 |
| 60/40 | 59.0 | 33.2 | 27.7 | 26.5 |
| 80/20 | 60.7 | 33.2 | 28.7 | 27.2 |
| 80/20 | 60.7 | 33.2 | 28.0 | 26.7 |
| 80/20 | 60.7 | 33.2 | 27.6 | 26.6 |
| 70/30 | 60.0 | 33.2 | 28.3 | 26.9 |
| 70/30 | 60.0 | 33.2 | 27.6 | 26.5 |
| 70/30 | 60.0 | 33.2 | 27.3 | 26.4 |

Initial water temperature 30.0° C. Dew point 24.8° C. Wet bulb 27.1°° C.

TABLE 5

| | | Ambient | Temp (° C.) | Temp (° C.) |
|---|---|---|---|---|
| Composition % | | Temp | after 5 | after 15 |
| (carbon/kaolin/Al) | Humidity | (° C.) | minutes | minutes |
| 10/90 | 62.0 | 32.0 | 28.7 | 26.8 |
| 10/90 | 62.0 | 32.0 | 28.1 | 26.4 |
| 10/90 | 62.0 | 32.0 | 27.5 | 26.4 |
| 0/100 | 62.5 | 32.0 | 28.4 | 26.6 |
| 0/100 | 62.5 | 32.0 | 27.7 | 26.4 |
| 0/100 | 62.5 | 32.0 | 27.3 | 26.4 |

Initial water temperature 30.1° C. Dew point 24.5° C. Wet bulb 26.4° C.

In each example, it can be seen that there was a significant reduction in air temperature due to evaporative cooling from the vessels, and this air temperature reduction occurred very quickly.

### Example 2

Climate control unit 10 comprising compositions described in the present disclosure were monitored in a laboratory throughout one day. The cooling effectiveness was monitored under various conditions of relative humidity, temperature, dew point, and wet bulb conditions. The external conditions were compared to microclimate conditions inside the laboratory. The microclimates were near space, which were close to the climate control unit, and far space, which were for the air in the rest of the room. The results are shown in graphs A-D of FIG. 16.

Graph A compares the near and far space humidity, graph B compares the near and far space temperature in Celsius, graph C plots the cylinder temperature in Celsius versus time of day, and graph D plots the indoor and outdoor temperatures in Celsius throughout the day in the space containing the cylinder. It can be seen that the climate control unit provided significant cooling of the environment.

Certain embodiments of the present invention were described above. From the foregoing it will be seen that this invention is one well adapted to attain all the ends and objects set forth above, together with other advantages, which are obvious in and inherent to the inventive apparatus disclosed herein. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative descriptions.

Accordingly, what is claimed is:

1. A composition of matter for use in making a ceramic object for climate control units and evaporative cooling, which ceramic object is effective under conditions of relative humidity greater than 45%, the composition of matter comprising a ceramic mixture comprising clay and carbon.

2. The composition of matter of claim 1, wherein the composition of matter further comprises aluminum.

3. The composition of matter of claim 1, wherein the composition of matter is shaped and then fired to create a ceramic object.

4. The composition of matter of claim 1, wherein the carbon of the composition of matter further comprises activated carbon.

5. The composition of matter of claim 4, wherein the activated carbon is produced from organic material by oxidizing the organic material, which is then mechanically reduced in size, and which organic material is thereafter heated to a high temperature.

6. The composition of matter of claim 5, wherein after heating the organic material, steam is introduced to initialize the activation.

7. The composition of matter of claim 4, wherein the activated carbon is mixed with a starch prior to activation.

8. A method of making a ceramic object for climate control units and evaporative cooling, which ceramic object is effective under conditions of relative humidity greater than 45%, wherein the ceramic object is made from a composition of matter comprising a ceramic mixture comprising clay and carbon, wherein the method comprises:
mixing clay with carbon and with water;
shaping the ceramic mixture into a shaped ceramic mixture; and
firing the shaped ceramic mixture.

9. The method of making a ceramic object of claim 8, wherein the firing of the shaped ceramic mixture is at a high temperature, to achieve greater strength and to produce needle mullites.

10. The method of making a ceramic object of claim 8, wherein the shaped ceramic mixture is bleached prior to being firing.

11. The method of making a ceramic object of claim 8, wherein:
the carbon is activated carbon;
the clay and activated carbon are mixed while both materials are dry;
whereafter water is added to form a wet ceramic mixture.

12. The method of making a ceramic object of claim 11, wherein the wet ceramic mixture is left wrapped for approximately a few days until a final semi-plastic consistency is achieved.

13. The method of making a ceramic object of claim 8, wherein the ceramic mixture comprises clay, activated carbon, and a metal, and wherein the mixing and shaping of the method further comprises:
mixing the clay and activated carbon and metal while dry to form a dry ceramic mixture;
then mixing cold water into the dry ceramic mixture;
then allowing the water to react with the metal;
then leaving the ceramic mixture to dry;
then crushing the dried ceramic mixture and leaving it exposed to air for approximately a few days to absorb moisture from air until a desired consistency is achieved.

14. An apparatus for climate control through evaporative cooling or condensing heating using a plurality of ceramic objects, the climate control apparatus comprising:
a tray with a concave depression;
wherein the tray contains up to approximately 5 mm of water; and
wherein the tray contains a plurality of ceramic objects.

15. The climate control apparatus of claim 14, in which the plurality of ceramic objects draw the water up to the surface of the plurality of ceramic objects by capillary action, from which plurality of ceramic objects the water evaporates.

16. The climate control apparatus of claim 14, wherein the tray further comprises a tray rim and a tray bottom.

17. The climate control apparatus of claim 14, wherein the tray further comprises side air inlets.

18. The climate control apparatus of claim 14, wherein the tray further comprises bottom air inlets, and comprises retainer insertions set above and around the bottom air inlets.

19. The climate control apparatus of claim 14, wherein the tray further comprises further comprises placement studs disposed on and fixedly attached to the underside of the tray.

20. The climate control apparatus of claim 14, wherein the tray further comprises a mesh, and wherein the mesh may be removably affixed to the top of the tray.
